(19) United States
(12) Patent Application Publication
(10) Pub. No.: US 2026/0081364 A1
(43) Pub. Date: Mar. 19, 2026

(54) QUICK POWER CONNECTION STRUCTURE

(71) Applicant: Zhongshan Leaves LED Lighting Technology CO.,Ltd, Zhongshan (CN)

(72) Inventor: Haohua ZENG, Zhongshan (CN)

(21) Appl. No.: 19/326,865

(22) Filed: Sep. 12, 2025

(30) Foreign Application Priority Data
Sep. 14, 2024 (CN) 202411294732.6

(51) Int. Cl. H01R 4/2406; H01B 7/02; H01B 9/02; H01R 4/01; H01R 4/2408; H01R 13/40

(52) U.S. Cl. CPC H01R 4/2406; H01B 7/0266; H01B 9/024; H01R 4/01; H01R 4/2408; H01R 13/40

(57) ABSTRACT

Provided is a quick power connection structure, which relates to the technical field of power connection, and comprises a cable and a quick connection member connected to the cable, wherein the cable comprises an insulator and a conductor, the quick connection member comprises conductive pins and an extrusion member, and the extrusion member is provided with a limiting structure, so that the conductive pins are unable to be continuously pierced into the cable by the extrusion member, and power connection positions at end portions of a plurality of conductive pins pierced into the cable are connected with corresponding conductor layers respectively; and an outer surface of a body portion of the conductive pin penetrating through the conductor layer is an insulator, so that the power connection position at the end portion of the conductive pin is in contact power connection with a target conductor layer.

### CROSS REFERENCE TO RELATED APPLICATIONS

This application claims foreign priority of Chinese Patent Application No. 202411294732.6, filed on Sep. 14, 2024 in the China National Intellectual Property Administration, the disclosures of all of which are hereby incorporated by reference.

### TECHNICAL FIELD

The present invention relates to the technical field of power connection, and is particularly a quick power connection structure.

### BACKGROUND OF THE PRESENT INVENTION

An existing quick power connection structure achieves the purpose of power connection by piercing conductive pins into a cable to make contact with conductors in the cable. Because electricity needs a loop, at least two conductive pins need to be connected with the conductors in two cables. In the prior art, the two cables are arranged side by side, and the two conductive pins are correspondingly arranged side by side, some of which are arranged up and down. No matter which arrangement mode of the two conductive pins is adopted, a direction of piercing into the cables is fixed. In order to ensure reliable piercing into the cables to make contact with the conductors, in an actual use scene, because the arrangement of the cables is fixed, postures of the cables are fixed, so that the direction of piercing the conductive pins into the cables can only be unchanged. Because some electrical facilities (such as an electric light source) are combined with the conductive pins, a relationship between positions of the electrical facilities and positions of the conductive pins is fixed, so that after achieving the power connection of the conductive pins, the positions of the electrical facilities are fixed. However, in some occasions, it is necessary to adapt the positions of the electrical facilities to use needs (such as an irradiation direction of the electric light source), so that the quick power connection structure in the prior art cannot meet the needs. In addition, the cables in the prior art are flexible and cannot keep their shapes stable, and even if some cables are combined on some stable members capable of being bent to deform and maintaining the deformed shape, the deformation is restricted by the side-by-side arrangement of two cables, and the cables cannot be deformed at will.

### SUMMARY OF THE PRESENT INVENTION

The present invention aims to provide a quick power connection structure which can overcome one or more of the above shortcomings and can achieve power connection in any direction around an axis of a cable.

A quick power connection structure of the present invention is implemented by comprising a cable and a quick connection member connected to the cable, wherein the cable comprises an insulator and more than two layers of conductors which are arranged in the insulator and arranged around an axis of the cable, the conductors are separated by the insulator, the quick connection member comprises conductive pins in a quantity matched with a quantity of layers of the conductors and an extrusion member (capable of being provided with an electrical facility) for pushing the conductive pins into the cable, a plurality of conductive pins are sequentially pierced into the cable in different positions of the cable under an action of the extrusion member, the extrusion member is provided with a limiting structure, and after the conductive pins pierced into the cable reach set positions, under limitation by the limiting structure, the conductive pins are unable to be continuously pierced into the cable by the extrusion member, and power connection positions at end portions of the plurality of conductive pins pierced into the cable are connected with corresponding conductor layers respectively; and an outer surface of a body portion of the conductive pin penetrating through the conductor layer is an insulator, so that the power connection position at the end portion of the conductive pin is in contact power connection with a target conductor layer, while the body portion of the conductive pin is unable to be in contact power connection with the conductor layer through which the conductive pin penetrates.

When in use, the cable is laid according to design requirements first, then the conductive pins are pierced into the cable by the extrusion member, and the conductive pins are sequentially pierced onto corresponding conductors of the cable and in contact power connection with the corresponding conductors, so that acquired electric energy is transmitted from the cable to a corresponding electrical facility (such as a light source arranged on the extrusion member or an electrical facility connected with the conductive pins through wires) through the conductive pins; the body portion of the conductive pin is wrapped with the insulator, and the body portion of the conductive pin cannot be in contact power connection with the conductor layer through which the conductive pin penetrates while connecting the power connection position at the end portion with the target conductor layer; and because the extrusion member may be connected to the cable around any position of the cable, a relationship between a position of the electrical facility fixedly connected with the extrusion member and a position of the conductive pin may be changed at will as required, thereby effectively enriching decorative effects.

Preferably, a first core strip is arranged on the axis of the cable, and the first core strip is a steel wire rope. By adopting the steel wire rope, the cable may be straightened and fixed between two positioning objects (such as two walls) by a fixing member (such as the technology of patent application CN202110805507.4), and by utilizing tensile and lifting properties of the steel wire rope, the electrical facility (such as the electric light source) is mounted on the straightened cable, so as to conveniently complete the layouts of power lines and electrical facilities.

Preferably, a second core strip is arranged on the axis of the cable, and the second core strip has a performance that a shape is able to be kept unchanged after bending and shaping. The second core strip is made of a material with a memory performance, the core strip made of this material can keep the shape stable under the condition that external environmental conditions are unchanged after bending and shaping, and when the external environmental conditions are changed (such as heating), the cable can restore its original physical state (such as restoring a vertical state); or, the second core strip is made of an elastic material, the core strip made of this material can keep the shape stable as long as a positioning structure is adopted at a key node for positioning after bending and shaping, and once the positioning by the positioning structure is cancelled, the second core strip can make the cable restore its original physical state (such as the vertical state).

Preferably, a cross section of the second core strip is circular.

By adopting the core strip with the circular cross section, the cable can be bent in any direction, thereby enriching bending shapes of the cable.

Preferably, the body portion of the conductive pin is cylindrical, and the power connection position at the end portion of the conductive pin is conical. The conductive pin can penetrate through the conductor layer, and meanwhile, when the power connection position at the end portion of the conductive pin reaches the target conductor layer, the conical surface in the power connection position at the end portion of the conductive pin can lean against the conductor layer, thereby ensuring the reliability of power connection.

Compared with the prior art, the present invention has the advantage that the cable is easy to be bent and shaped in layout in the case of achieving power connection in any direction around the axis of the cable.

### DESCRIPTION OF THE DRAWINGS

FIG. 1 is a schematic structural diagram of Embodiment 1 of a quick power connection structure according to the present invention;

FIG. 2 is an exploded view of FIG. 1;

FIG. 3 is a sectional view of a conductive pin pierced into a cable;

FIG. 4 is a schematic structural diagram of Embodiment 2 of the quick power connection structure according to the present invention; and

FIG. 5 is a schematic structural diagram of Embodiment 3 of the quick power connection structure according to the present invention.

Description of reference numerals: a refers to cable; b refers to quick connection member; 1 refers to insulator; 2 refers to conductor; 201 refers to threaded hole; 3 refers to conductive pin; 301 refers to power connection position at end portion; 302 refers to body portion; 4 refers to extrusion member; 401 refers to notch; 402 refers to base; 403 refers to pushing member; 404 refers to bottom surface; 405 refers to external thread; 5 refers to limiting structure; 6 refers to second core strip; and 7 refers to first core strip.

### DETAILED DESCRIPTION OF PREFERRED EMBODIMENTS

A quick power connection structure according to the present invention is further described in detail hereinafter with reference to the drawings and embodiments.

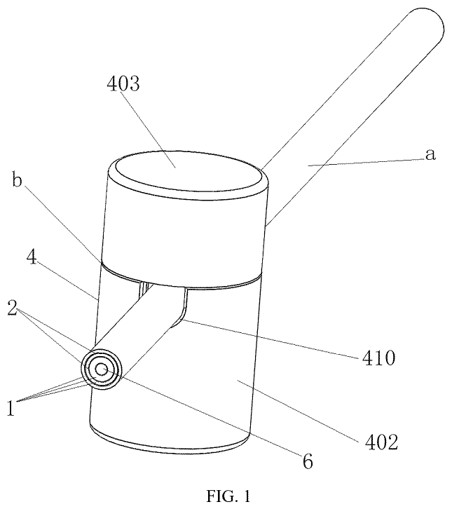

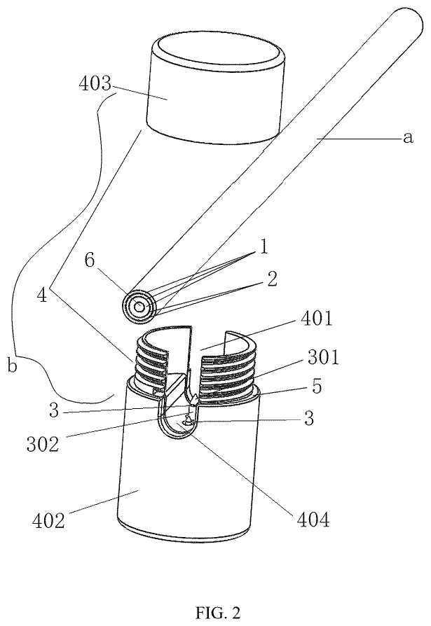

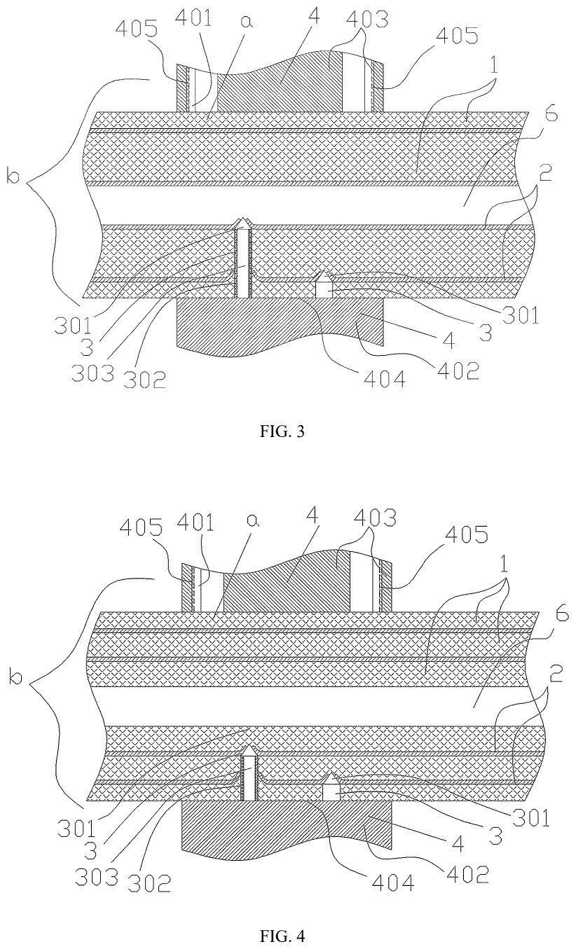

Embodiment 1: as shown in FIG. 1, FIG. 2 and FIG. 3, a quick power connection structure of the present invention is implemented by comprising a cable a and a quick connection member b connected to the cable a, wherein the cable a comprises an insulator 1 and more than two layers (two layers in the embodiment) of conductors 2 which are arranged in the insulator 1 and arranged around an axis of the cable, the conductors 2 are separated by the insulator 1, and the quick connection member b comprises conductive pins 3 (in a flat or cylindrical shape) in a quantity matched with a quantity of layers (two layers in the embodiment) of the conductors 2 and an extrusion member 4 for pushing the conductive pins 3 into the cable a. The extrusion member 4 comprises a base 402 having a notch 401 matched with the cable a and capable of being provided with an electrical facility (such as an electric light source fixed on the base 402 and provided with a power input end connected with the conductive pin 3) and a pushing member 403 for pushing the cable a towards the notch 401, two conductive pins 3 are fixed on a bottom surface 404 of the notch 401, and the two conductive pins 3 are distributed back and forth along an axis direction of the cable a.

Preferably, a cross section of the cable a is circular, and the notch 401 has a concave arc shape matched with a shape of the cable a. By adopting the notch 401 in the concave arc shape, the pushing member 403 pushes the cable a towards the notch 401, so that the cable a is attached to the bottom surface 404 of the notch 401. Because the notch 401 is in the concave arc shape matched with the shape of the cable a, the cable a will not be deformed, thereby making a power connection position 301 at an end portion of the conductive pin 3 pierced into the cable a in good contact with the matched conductor 2, and avoiding the situation that the power connection position 301 at the end portion of the conductive pin 3 pierced into the cable a fails to reach the matched conductor 2 or the conductive pin penetrates through the matched conductor 2 to fail to make contact with the matched conductor 2 due to the deformation of the cable a.

Preferably, an upper portion of the notch 401 is provided with an external thread 405, the pushing member 403 is a nut, the cable crosses the notch 401, and the pushing member 403 is screwed into the upper portion of the notch 401. Two conductive pins 3 are sequentially pierced into the cable a in different positions of the cable a under an action that the pushing member 403 of the extrusion member pushes the cable a to move towards the conductive pins 3, and the extrusion member 4 is provided with a limiting structure 5. The limiting structure 5 is a stopping surface at a bottom portion of the external thread, and the pushing member 403 is stopped on the stopping surface, so that the conductive pins 3 are unable to be continuously pierced into the cable a by the extrusion member 4, and the power connection positions 301 at the end portions of a plurality of conductive pins 3 pierced into the cable a are connected with corresponding layered conductors 2 respectively. An outer surface of a body portion 302 of the conductive pin 3 penetrating through the conductor 2 is an insulator, so that the power connection position 301 at the end portion of the conductive pin 3 is in contact power connection with a target layered conductor 2, while the body portion 302 of the conductive pin 3 is unable to be in contact power connection with the layered conductor 2 through which the conductive pin penetrates.

Certainly, there are many kinds of pushing members 403 for pushing the cable a towards the notch 401, comprising an extrusion piece connected to the base 402 through a bayonet connection structure; or, a swinging piece with one end connected to the base 402 and the other end connected to the base 402 through the bayonet connection structure.

Preferably, the body portion 302 of the conductive pin 3 is cylindrical, and the power connection position 301 at the end portion of the conductive pin is conical.

Preferably, a second core strip 6 is arranged on the axis of the cable a, and the second core strip 6 has a performance that a shape is able to be kept unchanged after bending and shaping. The second core strip 6 is made of a material with a memory performance, the second core strip made of this material can keep the shape stable under the condition that external environmental conditions are unchanged after bending and shaping, and when the external environmental conditions are changed (such as heating), the cable a can be driven to restore its original physical state (such as restoring a vertical state); or, the second core strip 6 is made of an elastic material, the second core strip 6 made of this material can keep the shape stable as long as a positioning structure (such as a positioning structure capable of being fixed on a ceiling, and clamping and fixing the cable a at the same time) is adopted at a key node for positioning after bending and shaping, and once the positioning by the positioning structure is cancelled, the second core strip 6 can drive the cable a to restore its original physical state (such as the vertical state).

Preferably, a cross section of the second core strip 6 is circular.

Preferably, as shown in FIG. 3 and FIG. 4, the conductive pin 3 penetrating through the layered conductor 2 comprises a columnar conductor 303 with a power connection position 301 at an end portion, and the insulator 302 wraps a body portion of the columnar conductor 303.

Embodiment 2: as shown in FIG. 4, in the embodiment, on the basis of Embodiment 1, an innermost layer of conductor 2 is wrapped on an outer surface of the second core strip 6, which not only facilitates manufacturing, but also reduces a manufacturing cost. In this way, the second core strip 6 wrapped with the conductor 2 can not only form one layer of conductor 2, but also reduce a cost of the second core strip 6 as the conductor. Serving as a material capable of ensuring shape stability after enabling plasticity, the second core strip 6 is very large in use amount, and common conductive copper and aluminum wires have a property of ensuring shape stability after enabling plasticity. However, due to the large use amount and the high material cost, if other plasticity materials (such as plastic materials) with the same performance are adopted, the materials are often poor conductors. This problem is solved by adopting the above structure.

Preferably, the conductor 2 is a braided conductor formed by wire braiding. The braided conductor not only facilitates making the conductive pin 3 penetrate through wires of the braided conductor, so as to reduce a damage to the conductor 2 caused by the conductive pin 3 penetrating through the conductor, but also improves bending resistance of the conductor 2.

Preferably, the insulator 1 is an insulating silica gel or an insulating braided fabric.

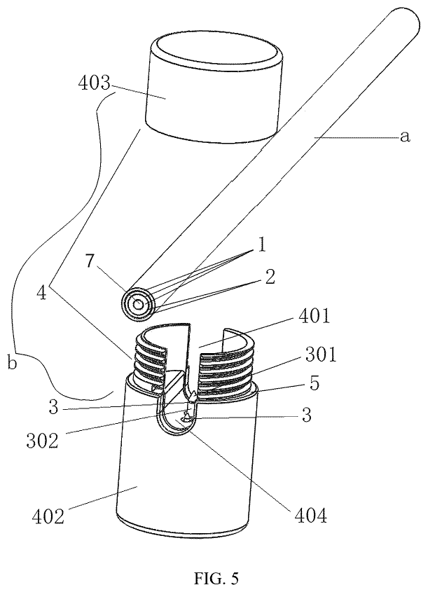

Embodiment 3: as shown in FIG. 5, in the embodiment, on the basis of Embodiments 1 and 2, a first core strip 7 is arranged on the axis of the cable a, and the first core strip 7 is a steel wire rope.

We claim:

1. A quick power connection structure, comprising a cable and a quick connection member connected to the cable, wherein the cable comprises an insulator and more than two layers of conductors which are arranged in the insulator and arranged around an axis of the cable, the conductors are separated by the insulator, the quick connection member comprises conductive pins in a quantity matched with a quantity of layers of the conductors and an extrusion member for pushing the conductive pins into the cable, a plurality of conductive pins are sequentially pierced into the cable in different positions of the cable under an action of the extrusion member, the extrusion member is provided with a limiting structure, and after the conductive pins pierced into the cable reach set positions, under limitation by the limiting structure, the conductive pins are unable to be continuously pierced into the cable by the extrusion member, and power connection positions at end portions of the plurality of conductive pins pierced into the cable are connected with corresponding conductor layers respectively, and an outer surface of a body portion of the conductive pin penetrating through the conductor layer is an insulator, so that the power connection position at the end portion of the conductive pin is in contact power connection with a target conductor layer, while the body portion of the conductive pin is unable to be in contact power connection with the conductor layer through which the conductive pin penetrates.

2. The quick power connection structure according to claim 1, wherein the extrusion member comprises a base having a notch matched with the cable and a pushing member for pushing the cable towards the notch, a cross section of the cable is circular, the notch has a concave arc shape matched with a shape of the cable, and the conductive pin is fixed on a bottom surface of the notch.

3. The quick power connection structure according to claim 2, wherein the plurality of conductive pins are distributed back and forth along an axis direction of the cable.

4. The quick power connection structure according to claim 1, wherein the body portion of the conductive pin is cylindrical, and the power connection position at the end portion of the conductive pin is conical.

5. The quick power connection structure according to claim 4, wherein a first core strip is arranged on the axis of the cable, and the first core strip is a steel wire rope.

6. The quick power connection structure according to claim 4, wherein a second core strip is arranged on the axis of the cable, a cross section of the second core strip is circular, and the second core strip has a performance that a shape is able to be kept unchanged after bending and shaping.

7. The quick power connection structure according to claim 6, wherein an innermost layer of conductor is wrapped on an outer surface of the second core strip.

8. The quick power connection structure according to claim 1, wherein the conductive pin penetrating through the conductor layer comprises a columnar conductor with a power connection position at an end portion, and the insulator wraps a body portion of the columnar conductor.

9. The quick power connection structure according to claim 2, wherein an upper portion of the notch is provided with an external thread, the pushing member is a nut, the cable crosses the notch, the pushing member is screwed into the upper portion of the notch, the limiting structure is a stopping surface at a bottom portion of the external thread, and the pushing member is stopped on the stopping surface.

10. The quick power connection structure according to claim 8, wherein an upper portion of the notch is provided with an external thread, the pushing member is a nut, the cable crosses the notch, the pushing member is screwed into the upper portion of the notch, the limiting structure is a stopping surface at a bottom portion of the external thread, and the pushing member is stopped on the stopping surface.

11. The quick power connection structure according to claim 1, wherein the conductor is a braided conductor formed by wire braiding.

12. The quick power connection structure according to claim 1, wherein the insulator is an insulating silica gel or an insulating braided fabric.

13. The quick power connection structure according to claim 11, wherein the insulator is an insulating silica gel or an insulating braided fabric.
